(19) United States
(12) Patent Application Publication
(10) Pub. No.: US 2021/0075558 A1
(43) Pub. Date: Mar. 11, 2021

(54) USER TERMINAL AND RADIO COMMUNICATION METHOD

(71) Applicant: NTT DOCOMO, INC., Tokyo (JP)

(72) Inventors: Kazuki TAKEDA, Tokyo (JP); Satoshi NAGATA, Tokyo (JP); Shaozhen GUO, Beijing (CN); Lihui WANG, Beijing (CN); Xiaolin HOU, Beijing (CN)

(21) Appl. No.: 17/045,063

(22) PCT Filed: Apr. 4, 2018
(86) PCT No.: PCT/JP2018/014444

§ 371 Date: Oct. 2, 2020

(51) Int. Cl. H04L 1/18; H04L 5/00; H04W 72/04

(52) U.S. Cl. CPC H04L 1/1819; H04W 72/0446; H04W 72/042; H04L 5/0055

(57) ABSTRACT

A user terminal is disclosed including a receiving section that monitors at least one of a first downlink control information format and a second downlink control information format in a plurality of search space sets configured for one or more cells to receive one or more pieces of downlink control information; and a control section that controls transmission of retransmission control information (HARQ-ACK) corresponding to the downlink control information, wherein at least one of a bit position of the HARQ-ACK and a downlink assignment index counter value (counter DAI value) is determined based on at least one of a cell index, a search space index, and a downlink control information format type. In another aspect, a radio communication method is also disclosed.

### TECHNICAL FIELD

The present invention relates to a user terminal and a radio communication method in next-generation mobile communication systems.

### BACKGROUND ART

In the UMTS (Universal Mobile Telecommunications System) network, the specifications of Long Term Evolution (LTE) have been drafted for the purpose of further increasing high speed data rates, providing lower latency and so on (see Non-Patent Literature 1). For the purpose of further broader band and higher speed than LTE (referred to as LTE Rel. 8 or Rel. 9), the specifications of LTE-A (LTE-Advanced, also referred to as LTE Rel. 10, Rel. 11, or Rel. 12) were drafted, and successor systems of LTE (referred to as, for example, FRA (Future Radio Access), 5G (5th generation mobile communication system), 5G+ (plus), NR (New Radio), NX (New radio access), FX (Future generation radio access), LTE Rel. 13, Rel. 14, Rel. 15 or later versions, and so on) are also under study.

In existing LTE systems (for example, LTE Rel. 8 to Rel. 13), downlink (DL) and/or uplink (UL) communications are carried out using 1 ms subframes (also referred to as “transmission time intervals (TTIs)” and so on). The subframe is a transmission time unit of one data packet coded by channel coding, and is a processing unit of scheduling, link adaptation, retransmission control (HARQ (Hybrid Automatic Repeat reQuest)), and so on.

A radio base station controls allocation (scheduling) of data for a user terminal, and notifies the user terminal of a scheduling of data by using downlink control information (DCI). The user terminal monitors a downlink control channel (PDCCH) on which downlink control information is transmitted to perform a receiving process (demodulation or decoding process, and the like), and controls DL data reception and/or uplink data transmission, based on the received downlink control information.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication system (hereinafter, also referred to as NR), a study is underway to use a method different from the existing LTE system to control transmission/reception of a DL signal (for example, downlink control information, downlink control channel, or the like). Accordingly, transmitting a retransmission control signal (also referred to as HARQ-ACK, ACK/NACK, or A/N) for DL transmission may also adopt a method different from those existing.

However, how to control the DL transmission (for example, downlink control information, downlink control channel, or the like) or the HARQ-ACK transmission is not still sufficiently studied. If a UE cannot appropriately perform the reception of the downlink control channel and the like, or the transmission of the HARQ-ACK, communication throughput is likely to decrease to deteriorate a communication quality.

An object of the present disclosure is to provide a user terminal and a radio communication method capable of suppressing communication quality deterioration even in a case that at least one of a DL signal, a HARQ-ACK, and the like is transmitted and received in a structure different from the existing LTE system.

### Solution to Problem

An aspect of a user terminal according to the present disclosure includes a receiving section that monitors at least one of a first downlink control information format and a second downlink control information format in a plurality of search space sets configured for one or more cells to receive one or more pieces of downlink control information, and a control section that controls transmission of retransmission control information (HARQ-ACK) corresponding to the downlink control information, wherein at least one of a bit position of the HARQ-ACK and a downlink assignment index counter value (counter DAI value) is determined based on at least one of a cell index, a search space index, and a downlink control information format type.

### Advantageous Effects of Invention

According to the present inventions, communication quality deterioration can be suppressed even in a case that at least one of a DL signal, a HARQ-ACK, and the like is transmitted in a structure different from the existing LTE system.

### BRIEF DESCRIPTION OF DRAWINGS

FIG. 1 is a diagram to show an example of a transmission method of a HARQ-ACK;

FIG. 2 is a diagram to show an example of a transmission method of a HARQ-ACK using a counter DAI and a total DAI;

FIG. 3 is a diagram to show an example of a DCI format including the counter DAI and the total DAI;

FIG. 4 is a diagram to show an example of a case of controlling a HARQ-ACK bit position;

FIGS. 5A and 5B are diagrams to show other examples of the case of controlling the HARQ-ACK bit position;

FIG. 6 is a diagram to show an example of another example of the case controlling the HARQ-ACK bit position;

FIG. 7 is a diagram to show another example of the case of controlling the HARQ-ACK bit position;

FIG. 8 is a diagram to show an example of a schematic structure of a radio communication system according to one embodiment of the present invention;

FIG. 9 is a diagram to show an example of an overall structure of a radio base station according to one embodiment of the present invention;

FIG. 10 is a diagram to show an example of a functional structure of the radio base station according to one embodiment of the present invention;

FIG. 11 is a diagram to show an example of an overall structure of a user terminal according to one embodiment of the present invention;

FIG. 12 is a diagram to show an example of a functional structure of the user terminal according to one embodiment of the present invention; and

FIG. 13 is a diagram to show an example of a hardware structure of the radio base station and the user terminal according to one embodiment of the present invention.

### DESCRIPTION OF EMBODIMENTS

In the existing LTE systems, a radio base station transmits downlink control information (DCI) by use of a downlink control channel (for example, PDCCH (Physical Downlink Control Channel) or an enhanced PDCCH (EPDCCH), or the like) to a UE. Transmitting the downlink control information may be interpreted as transmitting the downlink control channel.

The DCI may be, for example, scheduling information including at least one piece of information such as information indicating a time for scheduling data and a frequency resource, information indicating a transport block size, information indicating a data modulation scheme, information indicating a HARQ process identifier, information on a demodulation RS. The DCI for scheduling at least one of DL data reception and DL reference signal measurement may be referred to as a DL assignment or a DL grant. The DCI for scheduling at least one of UL data transmission and UL sounding (measurement) signal transmission may be referred to as a UL grant.

At least one of the DL assignment and the UL grant may include information on a resource, sequence, and transmission format of a channel used to transmit a UL control signal (UCI (Uplink Control Information)) such as a HARQ-ACK feedback for the DL data and channel measurement information (CSI (Channel State Information). The DCI for scheduling the UL control signal (UCI (Uplink Control Information)) may be defined separately from the DL assignment and the UL grant.

The UE is configured to monitor the certain number of sets of downlink control channel candidates in a certain time unit (for example, subframe). Here, the term “monitor” refers to, for example, attempting to decode each downlink control channel for a targeted DCI format in the relevant set. Such a decoding is also referred to blind decoding (BD) or blind detection. The downlink control channel candidate is also referred to as a BD candidate, a (E)PDCCH candidate, or the like.

A search area and search method for the downlink control channel candidate are defined as a search space (SS). The search space may be configured to include a plurality of search space sets (SS sets). In this case, one or a plurality of downlink control channel candidates are mapped to any search space set. In other words, the UE acquires the downlink control information (DCI) by monitoring the search space, or monitoring a certain DCI format in the search space set.

The UE may receive configuration information on a search space for PDCCH monitoring (also referred to as a search space configuration) from the base station. The search space configuration information may include information on a search space set configured for the UE. The search space configuration information may be notified to the UE through, for example, higher layer signaling (RRC signaling or the like). the search space set configured according to the search space configuration information may be configured to be associated with a control resource set (CORESET). Specifically, the UE can monitor the PDCCH based on at least two of the CORESET configuration information and the search space configuration information.

The search space configuration information includes mainly information on the PDCCH monitoring related configuration and decoding related configuration, and may include information on, for example, at least one of the following items.
Identifier of a search space set (search space set ID)
CORESET ID associated with the relevant search space set
Flag indicating whether the relevant search space set is a common search space (C-SS (Common SS)) that is configured common to the UE, or a UE-specific search space (UE-SS (UE-specific SS)) that is configured for each UE.
The number of PDCCH candidates for each aggregation level
Monitoring cycle
Monitoring offset
Monitoring pattern in a slot (for example, 14-bit bitmap)
Identifier of a cell (or a CC) associated with the search space set (cell ID or the like)

In NR, a study that the user terminal semi-statically or dynamically determines a HARQ-ACK size (also referred to as a HARQ-ACK codebook) to perform HARQ-ACK transmission by use of at least one of a PUCCH and a PUSCH is underway. The base station may notify the UE of a method for determining the HARQ-ACK codebook (semi-static or dynamic) through higher layer signaling, for example. The number of bits of the HARQ-ACK multiplexed on the PUCCH or the PUSCH is also referred to as a codebook size or the total number of bits.

In a case that the UE is configured with a mode for semi-statically determining the HARQ-ACK codebook, the UE determines the number of bits of the HARQ-ACK or the like, based on a structure configured through higher layer signaling. The structure configured through higher layer signaling (higher-layer configuration) may be include, for example, the maximum number of DL transmissions (for example, PDSCH) to be scheduled across a range associated with the HARQ-ACK feedback timing.

The range associated with the HARQ-ACK feedback timing corresponds to at least one (for example, all) of a space, a time, and a frequency (freq). The range associated with the HARQ-ACK feedback timing is also referred to as a monitoring occasion, a PDCCH monitoring occasion, a HARQ-ACK bundling window, a HARQ-ACK feedback window, a bundling window, or a feedback window.

In a case that the UE is configured with a mode for dynamically determining the HARQ-ACK codebook, the UE determines the number of bits of the HARQ-ACK or the like, based on a bit indicated in DL assignment index (DAI (downlink assignment indicator(index)) field included in the downlink control information (for example, DL assignment).

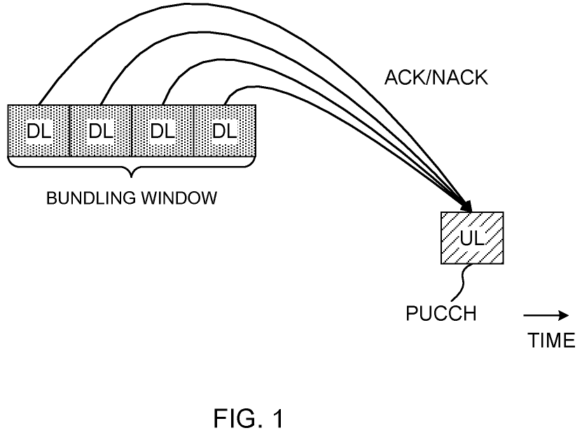

FIG. 1 is a diagram to show an example of HARQ-ACK feedback control by use of the PUCCH. In this example, portions designated by “DL” or “UL” represent certain resources (for example, time/frequency resource), and a period of each portion corresponds to any time unit (for example, one or more slots, mini-slots, symbols, subframes or the like). This also applies to the following examples.

In a case of FIG. 1, the UE transmits an A/N corresponding to the PDSCH scheduled in a certain range (for example, bundling window) associated with the HARQ-ACK feedback by use of a resource of a certain uplink control channel. A HARQ-ACK feedback timing for each PDSCH may be indicated to the UE by way of the downlink control information (for example, DL assignment) for scheduling each PDSCH.

In a case of applying a dynamic HARQ-ACK codebook, the codebook size of the HARQ-ACK to be multiplexed can be dynamically changed based on the number of scheduled PDSCHs. This can improve utilization efficiency of the resource to which the HARQ-ACK is allocated. In this case, the number of bits of the HARQ-ACK to be multiplexed may be considered to be determined based on the PDSCH received by the UE. However, if the UE fails to detect a portion or all of the DCI (or the PDCCH) for scheduling the PDSCH, the number of actually scheduled PDSCHs disadvantageously differs from the number of PDSCHs received by the UE.

As such, the UE controls the HARQ-ACK transmission (for example, HARQ-ACK codebook size, HARQ-ACK position order, or the like) base on the DL assignment index (DAI) included in the DCI indicating the DL transmission (for example, PDSCH).

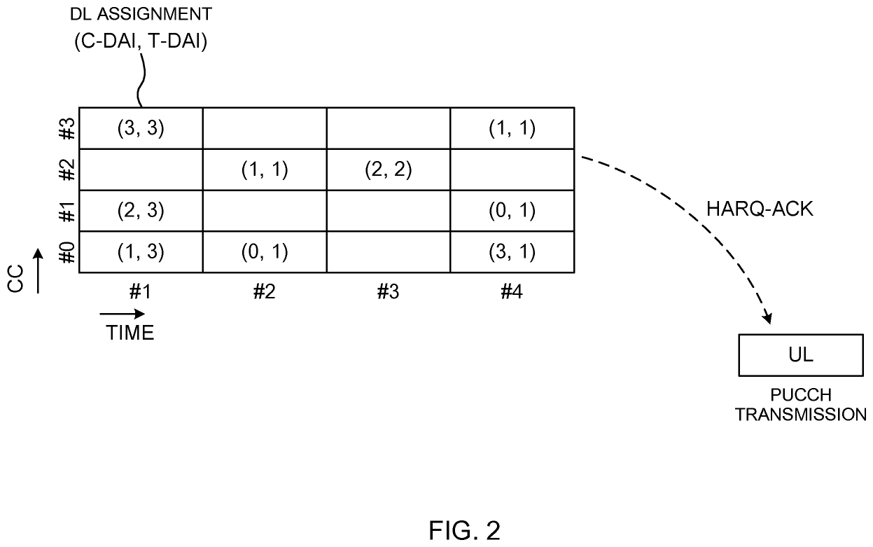

FIG. 2 shows an example of a case that the codebook size of the HARQ-ACK to be multiplexed on the PUCCH and the HARQ-ACK bit position (bits position) are determined based on the DAI included in the DCI. The HARQ-ACK bit position refers to the HARQ-ACK bit position (or the HARQ-ACK bits order) in a case that the UE transmits one or more HARQ-ACKs. By controlling the HARQ-ACK bit position (or order) in accordance with a certain rule, recognition of the HARQ-ACK corresponding to each PDSCH can be matched between the UE and the base station.

FIG. 2 shows a case that the UE is configured with four CCs (or cells) and four time units (for example, four slots) correspond to the range associated with the HARQ-ACK feedback timing (for example, bundling window). The bundling window may be determined based on the HARQ-ACK timing indicated by way of the downlink control information.

In FIG. 2, a PDSCH is scheduled in CC #0, CC #1, and CC #3 in the first slot. Similarly, a PDSCH is scheduled in CC #0 and CC #2 in the second slot, in CC #2 in the third slot, and in CC #0, CC #1, and CC #3 in the fourth slot. Specifically, this corresponds to a case that nine pieces of DL data are actually scheduled in the bundling window range (here, total number 16=4 CCs×4 slots).

In this case, the base station transmits information on the total number of pieces of DL data to be scheduled to the UE with being included in the downlink control information used to indicate the PDSCH scheduling. Note that in a case that the bundling window is configured with a plurality of time units, the base station may notify the DCI transmitted in each slot of the total number of pieces of DL data until each slot.

The information on the total number of pieces of DL data to be scheduled corresponds to the total number of bits of the HARQ-ACK (or a codebook size) fed back by the UE. The information on the total number of pieces of DL data to be scheduled may be referred to as a total DAI (T-DAI).

The DCI used for scheduling each PDSCH may include a counter DAI (C-DAI) in addition to the total DAI. The counter DAI indicates a cumulative total value of the scheduled data. For example, the downlink control information pieces of one or a plurality of CCs to be scheduled in a certain time unit (slot or subframe) may respectively include the counter DAIs numbered in the order of a CC index. In a case that the HARQ-ACKs for the DL data to be scheduled across a plurality of time units are collectively fed back (for example, in a case that the bundling window includes a plurality of slots), the counter DAI may apply across the plurality of time units.

FIG. 2 shows a case that each piece of the downlink control information indicating DL data scheduling includes the counter DAI and the total DAI in the bundling window. For example, for nine pieces of DL data scheduled, the counter DAI is accumulated in ascending order of a CC index from a period of a smaller slot index. Here, since a case that the counter DAI is two bits is shown, the pieces of the data scheduled in from CC #1 in the first slot to CC #4 in the fourth slot are repeatedly numbered in order of “1,” “2,” “3,” and “0”.

The total DAI indicates a sum (the total number) of pieces of the scheduled data. For example, the downlink control information pieces of one or a plurality of CCs to be scheduled in a certain time unit (slot or subframe) may respectively include the number of pieces of the data to be scheduled. That is, the total DAIs included in the downlink control information transmitted in the same slot have the same value. In the case that the HARQ-ACKs for the DL data to be scheduled across a plurality of time units are collectively fed back (for example, in the case that the bundling window includes a plurality of slots), the total DAI is set respectively across the plurality of time units.

In FIG. 2, since three pieces of DL data are scheduled in the first slot, the total DAI of the DL assignment transmitted in the first slot is 3 (“3”). Since two pieces of DL data are scheduled in the second slot (five pieces in total from the first slot), the total DAI of the DL assignment transmitted in the second slot is 5 (“1”). Since one piece of DL data is scheduled in the third slot (six pieces in total from the first slot), the total DAI of the DL assignment transmitted in the third slot is 6 (“2”). Since three pieces of DL data are scheduled in the fourth slot (nine pieces in total from the first slot), the total DAI of the DL assignment transmitted in the fourth slot is 9 (“1”).

FIG. 2 shows a case that each piece of the downlink control information indicating DL data scheduling includes the total DAI in the bundling window. The downlink control information for each slot includes, in the downlink control information, a sum of the number of pieces of DL data scheduled until each slot as the total DAI. Here, since the case is shown that the total DAI is two bits similar to the counter DAI, the counter DAI included in the downlink control information with the maximum CC index among the CCs in which the DL data is scheduled in a certain slot is the same as the total DAI value of the relevant slot.

Note that the counter DAI and the total DAI can be configured also based the number of codewords (CWs) not on the number of CCs. Although FIG. 2 shows a case that the counter DAI and the total DAI are configured based on the number of CCs (or a case that each CC is one CW), the counter DAI and the total DAI may be configured based on the number of CWs.

In a case that the UE is configured with a dynamic HARQ-ACK codebook through higher layer signaling or the like from the base station, the UE may control a HARQ-ACK bit position (also referred to as a HARQ-ACK bits order, or an A/N assignment order) to be fed back based on the counter DAI included in the downlink control information.

In a case that the counter DAI included in the downlink control information received by the UE is nonconsecutive, the UE feeds back the relevant nonconsecutive object (DL data) as a NACK to the base station. By doing so, even in a case that the UE fails to detect the downlink control information itself for scheduling the data of a certain CC, the UE can appropriately perform retransmission control by a feedback as a NACK even if the UE cannot recognize the CC failed to be detected.

In such a manner, the HARQ-ACK bits order is determined based on the value of the counter DAI (counter DAI value). The counter DAI value in a certain time unit (for example, PDCCH monitoring occasion) is determined based on the CC (or, cell) index.

Here, in the NR, a study is underway to define at least a first DCI format and a second DCI format as the DCI for scheduling the DL transmission (for example, PDSCH). The first DCI format and the second DCI format are so defined that they are different from each other in content, a payload size, and the like. The first DCI format may be referred to as DCI format 1_0 and the second DCI format may be referred to as DCI format 1_1.

Similarly, a study is underway to define at least DCI format 0_0 and DCI format 0_1 as the DCI for scheduling the UL transmission (for example, PUSCH).

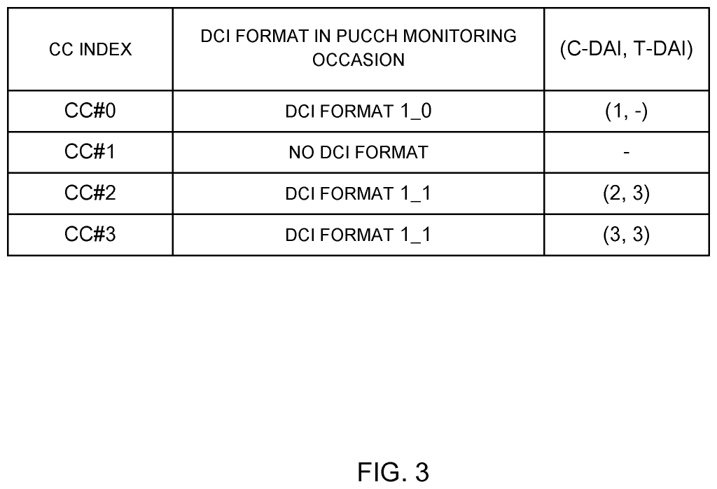

In the NR, the counter DAI is included in both the first DCI format and the second DCI format, whereas, a study is underway to configure the total DAI to be included in one DCI format. Specifically, the first DCI format may not include the total DAI, but the second DCI format may include the total DAI (see FIG. 3).

FIG. 3 shows an example of the DAI included in the DCI in a case that a PDSCH is scheduled in CC #0 in DCI format 1_0, a PDSCH is not scheduled in CC #1, a PDSCH is scheduled in CC #2 in DCI format 1_1, and a PDSCH is scheduled in CC #3 in DCI format 1_1. Note that the counter DAI included in each piece of DCI indicates a case of being accumulated in order of the CC index.

The UE may be configured to monitor only DCI formats 0_0 and 1_0, or only DCI formats 0_1 and 1_1 for each search space set. This is in order to reduce the number of blind decodes by monitoring only one kind of DCI formats whose sizes are the same (DCI formats 0_0 and 1_0, or DCI formats 0_1 and 1_1) for a certain search space set.

In a case that a plurality of search space sets are configured for one serving cell, the UE monitors the plurality of search space sets. For this reason, in the case that a plurality of search space sets are configured, the UE monitors only DCI formats 0_0 and 1_0, only DCI formats 0_1 and 1_1, or DCI formats 0_0 and 1_0 and DCI formats 0_1 and 1_1 on a case-by-case basis.

As described above, in a case that more than one search space set is configured for one CC, the UE monitors a plurality of DCI formats (for example, DCI formats 1_0 and 1_1, and the like) for the relevant CC for detection in some cases. In the case that the configuration of a plurality of search space sets for one CC (or detection of a plurality of DCI formats for one CC) is supported, how to control at least one of the HARQ-ACK bit position and the counter DAI is an issue.

The inventors of the present invention have focused on a point that at least one of a cell index, a search space set index between a plurality of search space sets, and a DCI format type is different in the case that a plurality of search space sets are configured, and have conceived of controlling the HARQ-ACK bit position based on at least one of the cell index, the search space index, and the downlink control information format type. Alternatively, the inventors of the present invention have conceived of controlling the counter DAI based on at least one of the cell index, the search space index, and the downlink control information format type.

Embodiments according to the present invention will be described in detail with reference to the drawings as follows. Aspects described below may be employed independently or in combination.

In the following description, the aspects can be applied to at least one of a case that a HARQ-ACK is multiplexed on an uplink control channel (for example, PUCCH) and a case that a HARQ-ACK is multiplexed on an uplink shared channel (for example, PUSCH). For example, in the following description, the downlink control information (DCI) may be applied to the DCI (DCI format 0_1 or 1_1) for scheduling UL transmission.

### (First Aspect)

In a first aspect, a HARQ-ACK bit position (position of HARQ-ACK bits) corresponding to a certain CC is controlled based on at least the search space index (SS index). The HARQ-ACK bit position may be interpreted as a HARQ-ACK bits position or a HARQ-ACK bits order. In a case that the HARQ-ACK bits order is associated with the counter DAI value, an order of the counter DAI values (for example, accumulation order) may be also controlled based on the SS index. The search space index may be referred to as a search space set index.

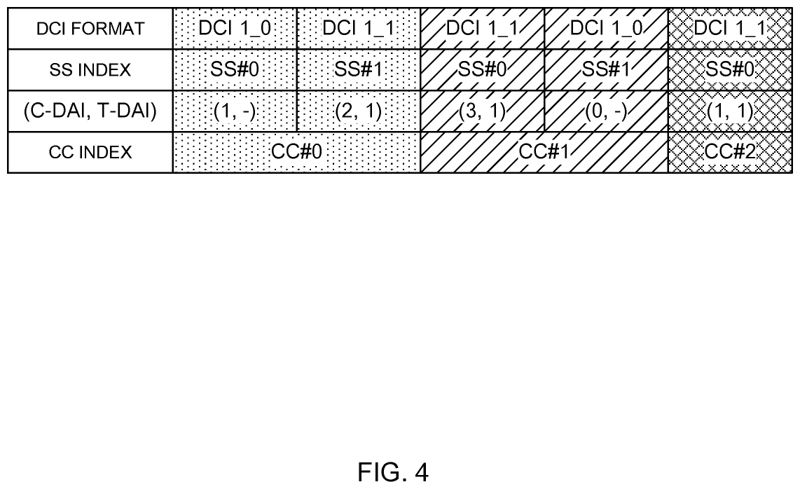

FIG. 4 is a diagram to show an example of a case that the HARQ-ACK bits order is controlled based on the CC index and the SS index. FIG. 4 shows a case that in a certain monitoring occasion, the DCI including scheduling information of the DL transmission (for example, PDSCH) is transmitted from each of CC #0, CC #1, and CC #2. Note that the number of CCs applicable to the present embodiment is not limited the above example.

In CC #0, the first DCI format (for example, DCI format 1_0) is assigned to SS index #0, and the second DCI format (for example, DCI format 1_1) is assigned to SS index #1. In CC #1, the second DCI format (for example, DCI format 1_1) is assigned to SS index #0, and the first DCI format (for example, DCI format 1_0) is assigned to SS index #1. In CC #2, the second DCI format (for example, DCI format 1_1) is assigned to SS index #0.

In a case that the UE detects the DCI including the scheduling information of the DL transmission in a plurality of search space sets, the UE controls the HARQ-ACK order corresponding to each DL transmission based on the CC index and the SS index.

For example, in a certain CC, the HARQ-ACK bits order is controlled such that the HARQ-ACK indexed by the lower SS index is prioritized more than the HARQ-ACK indexed by the higher SS index. Assume a case that in a certain CC, the UE detects the PDCCH (or the DCI) in a plurality of search space sets (for example, at SS index #0 and SS index #1). In this case, the UE transmits a HARQ-ACK for the PDSCH scheduled by way of the PDCCH (or the DCI) detected at SS index #0, and a HARQ-ACK for the PDSCH scheduled by way of the PDCCH (or the DCI) detected at SS index #1.

HARQ-ACK #0 corresponding to SS index #0 and HARQ-ACK #1 corresponding to SS index #1 may be transmitted at the same timing from the UE to the base station. In this case, the UE may control the HARQ-ACK bits order such that an order of HARQ-ACK #0 is prior to HARQ-ACK #1 in the HARQ-ACK bits to be transmitted.

In a case that the HARQ-ACK bits order is associated with the counter DAI value, the base station may control such that a cumulative total value of counter DAI value #0 is prior to counter DAI value #1. Specifically, counter DAI value #0 is configured to be counted up (or accumulated) prior to counter DAI value #1. Note that counter DAI value #0 corresponds to the counter DAI value included in the DCI assigned to SS index #0, and counter DAI value #1 corresponds to the counter DAI value included in the DCI assigned to SS index #1.

The HARQ-ACK order in different CCs may be controlled based on the CC index. For example, in a case that the HARQ-ACK order is controlled across a plurality of CCs, the HARQ-ACK indexed by the lower CC index may be prioritized. The UE firstly takes the CC index into consideration, and next, takes the SS index in the same CC into consideration to control the HARQ-ACK bits order.

For example, in FIG. 4, the UE firstly prioritizes the lower CC index (CC #0>CC #1>CC #2). Next, the HARQ-ACK corresponding to the same CC index indexed by the lower SS index is prioritized (SS #0>SS #1).

In FIG. 4, the UE controls the HARQ-ACK order to be in order of SS #0 in CC #0, SS #1 in CC #0, SS #0 in CC #1, SS #1 in CC #1, and SS #0 in CC #2.

In the case that the HARQ-ACK bits order is associated with the counter DAI value, the base station may control the counter DAI value included in each piece of DCI such that the order is to be in order of SS #0 in CC #0, SS #1 in CC #0, SS #0 in CC #1, SS #1 in CC #1, and SS #0 in CC #2. FIG. 4 shows a case that the counter DAI in each piece of DCI is counted up based on such an order (1->2->3->0->1).

Here, since five DL transmissions to be scheduled are provided, the total DAI value is 1. The base station includes the total DAI in a certain DCI format (for example, the second DCI format) and does not include the total DAI in other DCI formats (for example, the first DCI format).

In this way, by controlling the HARQ-ACK order based on the CC index and the SS index, the HARQ-ACK position can be appropriately controlled even in the case that a plurality of search space sets are configured.

### (Second Aspect)

In a second aspect, a HARQ-ACK bits position corresponding to a certain CC is controlled based on at least the DCI format type. In the case that the HARQ-ACK bits order is associated with the counter DAI value, an order of the counter DAI values may be also controlled based on the DCI format type.

For example, the HARQ-ACK bits order is controlled such that a DCI format including certain information is prioritized more than another DCI format. The certain information may be the total DAI or other information. In a case that the certain information is the total DAI, the HARQ-ACK bits order may be controlled such that the second DCI format (for example, DCI format 1_1) is prioritized more than the first DCI format (for example, DCI format 1_0).

Assume a case that in a certain CC, the UE detects the PDCCH (or the DCI) in a plurality of search space sets (for example, at SS index #0 and SS index #1). In this case, the UE transmits HARQ-ACK #0 for PDSCH #0 scheduled by way of PDCCH #0 (or DCI #0) detected at SS index #0, and HARQ-ACK #1 for PDSCH #1 scheduled by way of PDCCH #1 (or DCI #1) detected at SS index #1.

HARQ-ACK #0 corresponding to SS index #0 and HARQ-ACK #1 corresponding to SS index #1 may be transmitted at the same timing from the UE to the base station. In this case, the UE controls the HARQ-ACK bits order based on the DCI format type of DCI #0 and the DCI format type of DCI #2. Note that in a case that a plurality of HARQ-ACKs corresponding to the same DCI format type are present in a certain CC, the HARQ-ACK bits order may be controlled based on another condition (for example, SS index).

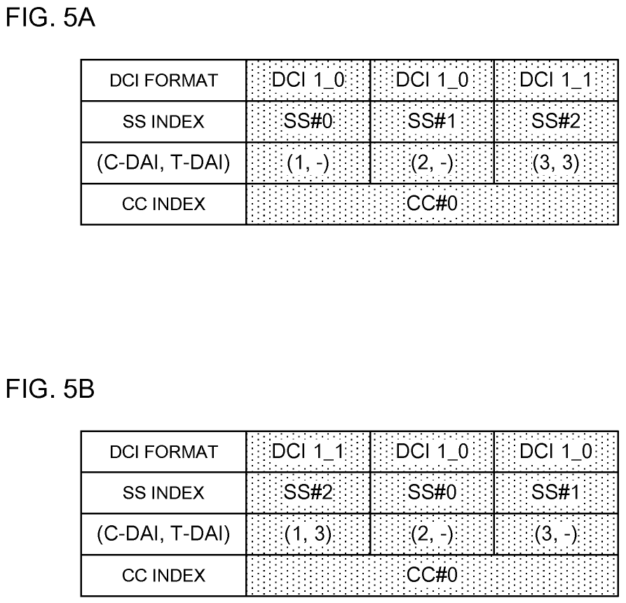

FIG. 5 shows a control example of the HARQ-ACK order in a certain CC (here, CC #0). FIG. 5A shows a case of controlling the HARQ-ACK bits order with the SS index being prioritized more than the DCI format type. FIG. 5B shows a case of controlling the HARQ-ACK bits order with the DCI format type being prioritized more than the SS index. Here, a case, as a priority order of the DCI format type, is shown that the second DCI format including the total DAI is prioritized more than the first DCI format not including the total DAI.

Assume, in FIG. 5A, a case that the UE fails to detect the PDCCH (or the second DCI format) allocated to SS #2. In this case, the UE receives a PDSCH scheduled in the first DCI format assigned to SS #0 and SS #1 and transmits a HARQ-ACK for the PDSCH.

However, the UE cannot recognize the second DCI format assigned to SS #2, and thus, the UE cannot receive the total DAI. In this case, based on the maximum counter DAI value (here, 2), the UE recognizes that the number of DL transmissions scheduled in CC #0 is two. As such, in a case of dynamically controlling the HARQ-ACK codebook, the UE does not conform with the base station in the recognition of the HARQ-ACK codebook size, which is likely to deteriorate the communication quality.

Next, assume, in FIG. 5B, a case that the UE fails to detect the PDCCH (or the second DCI format) allocated to SS #2. In this case, the UE receives a PDSCH scheduled in the first DCI format assigned to SS #0 and SS #1 and transmits a HARQ-ACK for the PDSCH.

Although the UE cannot recognize the second DCI format assigned to SS #2, the UE can recognize that, based on the maximum counter DAI value (here, 3), the number of DL transmissions scheduled in CC #0 is three. By doing so, the UE can conform with the base station in the recognition of the HARQ-ACK codebook size even in the case of failing to detect the DCI format including the total DAI. As a result, the deterioration of the communication quality can be suppressed.

Note that, in FIG. 5B, in a case that the UE fails to detect SS #1 that is in the last in the accumulation order of the counter DAI value, the UE can appropriately determine the total number of DL transmissions scheduled in CC #0, based on the total DAI included in the DCI detected in SS #2.

In this way, the HARQ-ACK bits order (or the counter DAI value) is controlled base on the DCI format type. This allows the HARQ-ACK codebook size to be appropriately determined, even in the case that the UE fails to detect a certain DCI format.

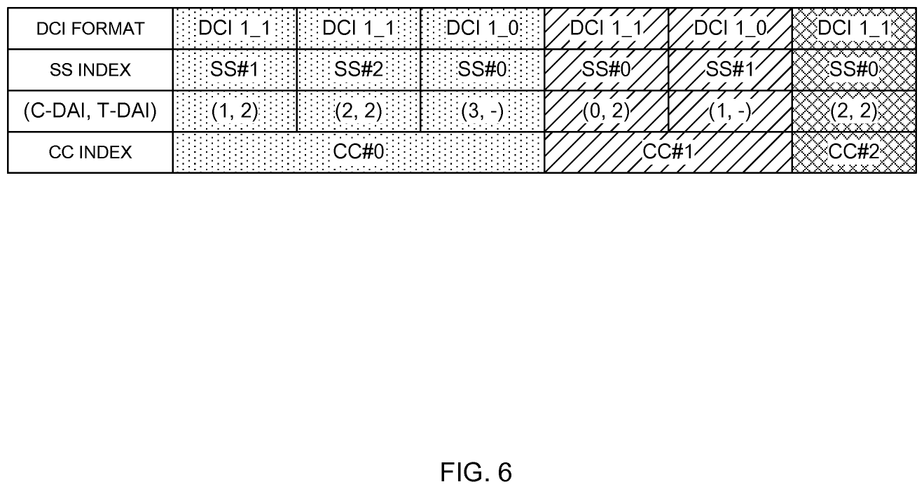

FIG. 6 shows an example of a case that the HARQ-ACK bits order (or the accumulation order of the counter DAI value) is controlled based on the CC index, the DCI format type, and the SS index. FIG. 6 shows a case that in a certain monitoring occasion, the DCI including scheduling information of the DL transmission (for example, PDSCH) is transmitted from each of CC #0, CC #1, and CC #2.

In CC #0, the first DCI format (for example, DCI format 1_0) is assigned to SS index #0, and the second DCI format (for example, DCI format 1_1) is assigned to each of SS indexes #1 and #2. In CC #1, the second DCI format (for example, DCI format 1_1) is assigned to SS index #0, and the first DCI format (for example, DCI format 1_0) is assigned to SS index #1. In CC #2, the second DCI format (for example, DCI format 1_1) is assigned to SS index #0.

In a case that the UE detects the DCI for scheduling the DL transmission in a plurality of search space sets, the UE controls the HARQ-ACK order corresponding to each DL transmission based on the CC index, the DCI format type, and the SS index.

For example, the UE firstly prioritizes the lower CC index (for example, CC #0>CC #1>CC #2). Next, the HARQ-ACK corresponding to the same CC index in a certain DCI format (for example, the second DCI format) is prioritized (DCI format 1_1>DCI format 1_0). Next, the HARQ-ACK corresponding to the same DCI format indexed by the lower SS index is prioritized (SS #0>SS #1).

In FIG. 6, the UE controls the HARQ-ACK order to be in order of SS #1 in CC #0, SS #2 in CC #0, SS #0 in CC #0, SS #0 in CC #1, SS #1 in CC #1, and SS #0 in CC #2.

In the case that the HARQ-ACK bits order is associated with the counter DAI value, the base station may control the counter DAI value included in each piece of DCI such that the order is to be in order of SS #1 in CC #0, SS #2 in CC #0, SS #0 in CC #0, SS #0 in CC #1, SS #1 in CC #1, and SS #0 in CC #2. FIG. 6 shows a case that the counter DAI in each piece of DCI is counted up in such order (1->2->3->0->1->2).

Here, since six DL transmissions to be scheduled are provided, the total DAI value is 2. The base station includes the total DAI in a certain DCI format (for example, the second DCI format) and does not include the total DAI in other DCI formats (for example, the first DCI format).

In this way, by controlling the HARQ-ACK order based on the DCI format type, the HARQ-ACK codebook size can be grasped and the HARQ-ACK position can be appropriately controlled even in the case of failing to detect a certain DCI format (for example, the DCI format including the total DAI).

### (Third Aspect)

In a third aspect, a HARQ-ACK bits position is controlled across a plurality of CCs, based on at least the DCI format type. In the case that the HARQ-ACK bits order is associated with the counter DAI value, an order of the counter DAI values may be also controlled based on the DCI format type.

For example, the HARQ-ACK bits order is controlled across a plurality of CCs such that a DCI format including certain information is prioritized more than another DCI format. The certain information may be the total DAI or other information. In a case that the certain information is the total DAI, the HARQ-ACK bits order may be controlled such that the second DCI format (for example, DCI format 1_1) is prioritized more than the first DCI format (for example, DCI format 1_0).

In a case that a plurality of HARQ-ACKs corresponding to the same DCI format type are present across a plurality of CCs, the HARQ-ACK bits order may be controlled based on another condition (for example, at least one of the CC index and the SS index).

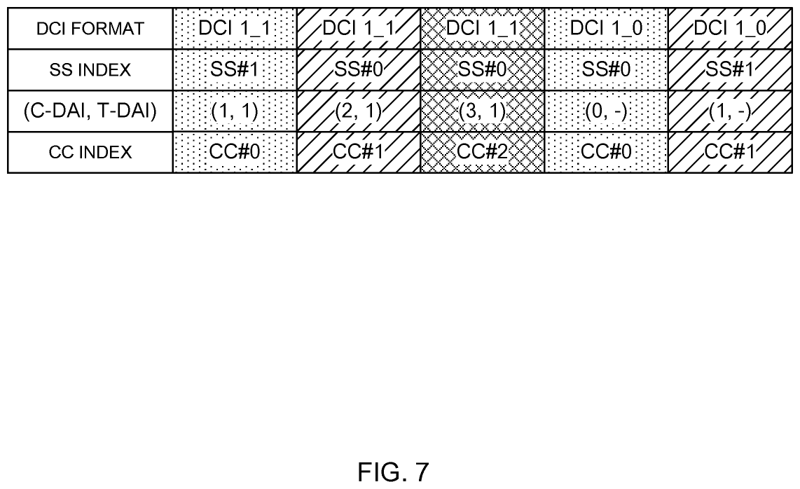

FIG. 7 shows an example of a case that the HARQ-ACK bits order (or the accumulation order of the counter DAI value) is controlled based on the DCI format type, the CC index, and the SS index. FIG. 7 shows a case that in a certain monitoring occasion, the DCI for scheduling the DL transmission (for example, PDSCH) is transmitted from each of CC #0, CC #1, and CC #2.

In CC #0, the first DCI format (for example, DCI format 1_0) is assigned to SS index #0, and the second DCI format (for example, DCI format 1_1) is assigned to SS index #1. In CC #1, the second DCI format (for example, DCI format 1_1) is assigned to SS index #0, and the first DCI format (for example, DCI format 1_0) is assigned to SS index #1. In CC #2, the second DCI format (for example, DCI format 1_1) is assigned to SS index #0.

In a case that the UE detects the DCI for scheduling the DL transmission in a plurality of search space sets, the UE controls the HARQ-ACK order corresponding to each DL transmission based on the DCI format type, the CC index, and the SS index.

For example, the UE firstly prioritizes a certain DCI format type (for example, the second DCI format) (DCI format 1_1>DCI format 1_0). Next, the HARQ-ACK corresponding to the same DCI format indexed by the lower CC index is prioritized (for example, CC #0>CC #1>CC #2). Next, the HARQ-ACK corresponding to the same CC index indexed by the lower SS index is prioritized (SS #0>SS #1).

In FIG. 7, the UE controls the HARQ-ACK order to be in order of SS #1 in CC #0, SS #0 in CC #1, SS #0 in CC #2, SS #0 in CC #0, and SS #1 in CC #1.

In the case that the HARQ-ACK bits order is associated with the counter DAI value, the base station may control the counter DAI value included in each piece of DCI such that the order is to be in order of SS #1 in CC #0, SS #0 in CC #1, SS #0 in CC #2, SS #0 in CC #0, and SS #1 in CC #1. FIG. 7 shows a case that the counter DAI in each piece of DCI is counted up in such order (1->2->3->0->1).

Here, since five DL transmissions to be scheduled are provided, the total DAI value is 1. The base station includes the total DAI in a certain DCI format (for example, the second DCI format) and does not include the total DAI in other DCI formats (for example, the first DCI format).

In this way, by controlling the HARQ-ACK order in a plurality of CCs based on the DCI format type, the HARQ-ACK codebook size can be grasped and the HARQ-ACK position can be appropriately controlled even in the case of failing to detect a certain DCI.

Note that in FIG. 7, the HARQ-ACK order may be configured to be determined with the SS index being prioritized more than the CC index.

### (Fourth Aspect)

In a fourth aspect, the HARQ-ACK bit position is controlled based on at least a BWP. The HARQ-ACK bit position may be interpreted as the HARQ-ACK bits order. In the case that the HARQ-ACK bits order is associated with the counter DAI value, an order of the counter DAI values may be also controlled based on the BWP.

In the future radio communication system (hereinafter, referred to as NR), a study is underway to use one or more partial frequency bands (also referred to as partial bands, bandwidth parts (BWPs), and the like) in the CC for the DL and/or UL communication (DL/UL communication).

In a structure configured with the BWP, an active BWP is configured in each CC. In each CC, BWP activation or deactivation may be controlled.

The BWP used for the DL communication may be referred to as a DL BWP (frequency band for DL), and the BWP used for the UL communication may be referred to as a UL BWP (frequency band for UL). The DL BWP and the UL BWP may overlap in at least a part of the frequency band. Hereinafter, the DL BWP and the UL BWP will be collectively referred to as the BWP, unless specified otherwise.

At least one of the DL BWPs configured for the user terminal (for example, DL BWP included in a primary CC) may include a control resource region that is to be a DL control channel (DCI) allocation candidate. The control resource region may also be referred to as a control resource set (CORESET), a control subband, a search space set, a search space resource set, a control region, a control subband, a NR-PDCCH region, or the like).

The user terminal monitors one or more search spaces in the control resource set to detect the DCI for the user terminal. The search space may include a common search space (CSS) in which the DCI common to one or more user terminals (for example, group DCI or common DCI) is arranged. The search space may also include a user terminal (UE)-specific search space (USS) in which the user terminal-specific DCI (for example, DL assignment and/or UL grant) is arranged.

In one or a plurality of CCs, a plurality of active BWPs may be considered to be provided to each CC. In a case that a plurality of BWPs are configured in a certain CC, how to control a transmission of a HARQ-ACK for a DL transmission that is transmitted on each BWP (for example, PDSCH) is an issue.

As such, in the fourth aspect, a BWP index is taken into consideration to control the HARQ-ACK transmission. Hereinafter, a control example of the HARQ-ACK order (or the accumulation order of the counter DAI values) will be described. Note that control examples 1 to 4 described below may be employed independently or in combination.

### Control Example 1

The HARQ-ACK order is controlled based on the SS index, the BWP index, and the CC index.

For example, in a case that a plurality of CCs for each of which the BWP is configured are configured, the lower SS index is prioritized in a certain BWP in a certain CC (the lower SS index is arranged higher). Next, in a case that a plurality of BWPs are provided in a certain CC, the BWP indexed by the lower BWP index is prioritized. Next, the lower CC index is prioritized across a plurality of CCs.

In other words, in a plurality of CCs, the CC indexed by the lower CC index is prioritized. Next, the HARQ-ACK corresponding to the same CC index indexed by the lower BWP index is prioritized. Next, the HARQ-ACK corresponding to the same BWP index indexed by the lower SS index is prioritized.

In this way, by controlling the HARQ-ACK order in consideration of the BWP index, the HARQ-ACK order can be appropriately controlled even in a case that a plurality of BWPs are active in a certain CC and a plurality of PDSCHs are scheduled for the plurality of BWPs.

### Control Example 2

The HARQ-ACK order is controlled based on the DCI format type and at least one of the SS index, the BWP index, and the CC index. Here, the HARQ-ACK bits order is controlled base on the DCI format type in a certain BWP range in a certain CC.

In the case that a plurality of CCs for each of which the BWP is configured are configured, a certain DCI format in a certain BWP in a certain CC (or a search space set, indexed by the lower SS index, for which a certain DCI format is monitored) is prioritized. For example, the second DCI format (for example, DCI format 1_1) is preferentially selected, and thereafter, the first DCI format (for example, DCI format 1_0) is selected. Next, in a case that a plurality of BWPs are provided in a certain CC, the BWP indexed by the lower BWP index is prioritized. Next, in a case that a plurality of CCs are provided, the CC indexed by the lower CC index is prioritized.

In other words, in a plurality of CCs, the CC indexed by the lower CC index is prioritized. Next, the HARQ-ACK corresponding to the same CC index indexed by the lower BWP index is prioritized. Next, the HARQ-ACK corresponding to the same BWP index in a certain DCI format is prioritized.

In this way, by controlling the HARQ-ACK order based on the CC index and the SS index, the HARQ-ACK position can be appropriately controlled even in the case that a plurality of search space sets are configured.

### Control Example 3

The HARQ-ACK order is controlled based on the DCI format type and at least one of the SS index and the CC index. Here, the HARQ-ACK bits order is controlled base on the DCI format type across a plurality of BWPs in a certain CC.

In the case that a plurality of CCs for each of which the BWP is configured are configured, a certain DCI format across one or a plurality of BWPs in a certain CC (or a search space set, indexed by the lower SS index, for which a certain DCI format is monitored) is prioritized. For example, the second DCI format (for example, DCI format 1_1) is preferentially selected, and thereafter, the first DCI format (for example, DCI format 1_0) is selected. Next, in a case that a plurality of CCs are provided, the CC indexed by the lower CC index is prioritized.

In other words, in a plurality of CCs, the CC indexed by the lower CC index is prioritized. Next, the HARQ-ACK corresponding to the same CC index in a certain DCI format is prioritized. Next, the HARQ-ACK corresponding to the same DCI format indexed by the lower SS index is prioritized.

### Control Example 4

The HARQ-ACK order is controlled based on the DCI format type. Here, the HARQ-ACK bits order is controlled base on the DCI format type across a plurality of CCs and a plurality of BWPs.

For example, in the case that a plurality of CCs for each of which the BWP is configured are configured, a certain DCI format across a plurality of BWPs in a plurality of CCs (or a search space set, indexed by the lower SS index, for which a certain DCI format is monitored) is prioritized. For example, the second DCI format (for example, DCI format 1_1) is preferentially selected, and thereafter, the first DCI format (for example, DCI format 1_0) is selected.

In this way, by controlling the HARQ-ACK order in a plurality of CCs based on the DCI format type, the HARQ-ACK codebook size can be grasped and the HARQ-ACK position can be appropriately controlled even in the case of failing to detect a certain DCI.

### (Variations)

Note that the above description assumes the case that the monitoring occasion (or the bundling window) constituted by one time unit (for example, 1 slot), but may be applied to a case of a constitution by a plurality of time units likewise.

In a case that the bundling window is constituted by a plurality of time units (for example, slots), the above first to fourth aspects may be applied for each slot (in slot unit). Alternatively, the HARQ-ACK order may be determined with at least one of the CC index, the SS index, the DCI format type, and the BWP index being prioritized more than a time index (slot index).

For example, in a case that the bundling window constituted by two slots, the HARQ-ACK order (or the accumulation order of the counter DAI values) may be controlled such that a HARQ-ACK corresponding to a certain DCI format (for example, DCI format 1_1) is prioritized across these two slots.

### (Radio Communication System)

Hereinafter, a structure of a radio communication system according to one embodiment of the present invention will be described. In this radio communication system, the radio communication method according to each embodiment of the present invention described above may be used alone or may be used in combination for communication.

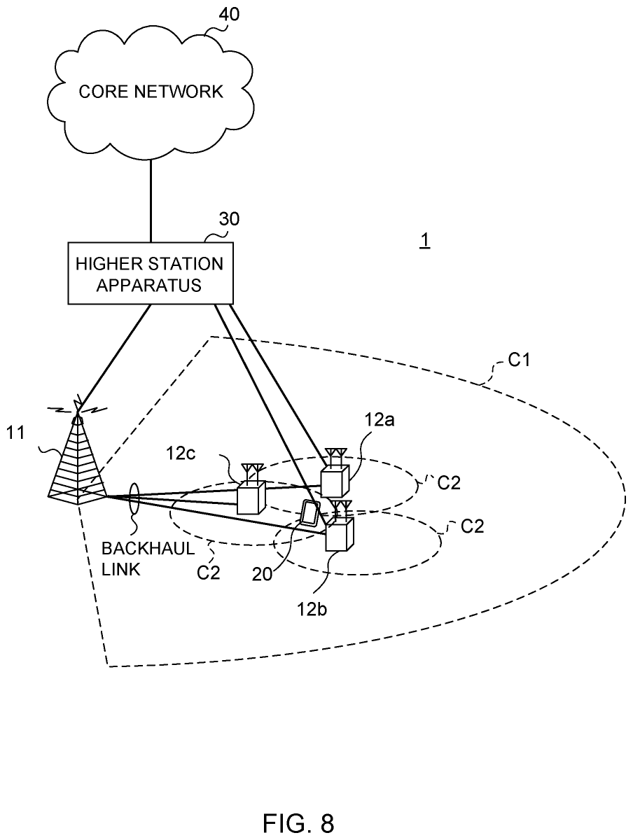

FIG. 8 is a diagram to show an example of a schematic structure of the radio communication system according to one embodiment of the present invention. A radio communication system 1 can adopt carrier aggregation (CA) and/or dual connectivity (DC) to group a plurality of fundamental frequency blocks (component carriers) into one, where the system bandwidth in an LTE system (for example, 20 MHz) constitutes one unit.

Note that the radio communication system 1 may be referred to as “LTE (Long Term Evolution),” “LTE-A (LIE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be referred to as a system implementing these.

The radio communication system 1 includes a radio base station 11 that forms a macro cell C1 of a relatively wide coverage, and radio base stations 12 (12a to 12c) that form small cells C2, which are placed within the macro cell C1 and which are narrower than the macro cell C1. Also, user terminals 20 are placed in the macro cell C1 and in each small cell C2. The position, the number, and the like of each cell and user terminal 20 are by no means limited to the aspect shown in the diagram.

The user terminals 20 can connect with both the radio base station 11 and the radio base stations 12. It is assumed that the user terminals 20 use the macro cell C1 and the small cells C2 at the same time by means of CA or DC. The user terminals 20 may adopt CA or DC by using a plurality of cells (CCs) (for example, five or less CCs, or six or more CCs).

Between the user terminals 20 and the radio base station 11, communication can be carried out by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. Note that the structure of the frequency band for use in each radio base station is by no means limited to these.

The user terminals 20 can perform communication by using time division duplex (TDD) and/or frequency division duplex (FDD) in each cell. Furthermore, in each cell (carrier), a single numerology may be employed, or a plurality of different numerologies may be employed.

A wired connection (for example, means in compliance with the CPRI (Common Public Radio Interface) such as an optical fiber, an X2 interface and so on) or a wireless connection may be established between the radio base station 11 and the radio base stations 12 (or between two radio base stations 12).

The radio base station 11 and the radio base stations 12 are each connected with a higher station apparatus 30, and are connected with a core network 40 via the higher station apparatus 30. Note that the higher station apparatus 30 may include, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. The radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

Each of the user terminals 20 is a terminal that supports various communication schemes such as LTE and LTE-A, and may include not only mobile communication terminals (mobile stations) but stationary communication terminals (fixed stations).

In the radio communication system 1, as radio access schemes, orthogonal frequency division multiple access (OFDMA) is applied to the downlink, and single carrier frequency division multiple access (SC-FDMA) and/or OFDMA is applied to the uplink.

OFDMA is a multi-carrier communication scheme to perform communication by dividing a frequency band into a plurality of narrow frequency bands (subcarriers) and mapping data to each subcarrier. SC-FDMA is a single carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combinations of these, and other radio access schemes may be used.

In the radio communication system 1, a downlink shared channel (PDSCH (Physical Downlink Shared Channel), which is used by each user terminal 20 on a shared basis, a broadcast channel (PBCH (Physical Broadcast Channel)), downlink L1/L2 control channels and so on, are used as downlink channels. User data, higher layer control information, SIBs (System Information Blocks) and so on are communicated on the PDSCH. The MIBs (Master Information Blocks) are communicated on the PBCH.

The downlink L1/L2 control channels include a PDCCH (Physical Downlink Control Channel), an EPDCCH (Enhanced Physical Downlink Control Channel), a PCFICH (Physical Control Format Indicator Channel), a PHICH (Physical Hybrid-ARQ Indicator Channel) and so on. Downlink control information (DCI), including PDSCH and/or PUSCH scheduling information, and so on are communicated on the PDCCH.

Note that the scheduling information may be reported by the DCI. For example, the DCI scheduling DL data reception may be referred to as “DL assignment,” and the DCI scheduling UL data transmission may be referred to as “UL grant.”

The number of OFDM symbols to use for the PDCCH is communicated on the PCFICH. Acknowledgment information (for example, also referred to as “retransmission control information,” “HARQ-ACK,” “ACK/NACK,” and so on) of HARQ (Hybrid Automatic Repeat reQuest) for a PUSCH is transmitted on the PHICH. The EPDCCH is frequency-division multiplexed with the PDSCH (downlink shared data channel) and used to communicate DCI and so on, like the PDCCH.

In the radio communication system 1, an uplink shared channel (PUSCH (Physical Uplink Shared Channel)), which is used by each user terminal 20 on a shared basis, an uplink control channel (PUCCH (Physical Uplink Control Channel)), a random access channel (PRACH (Physical Random Access Channel)) and so on are used as uplink channels. User data, higher layer control information and so on are communicated on the PUSCH. In addition, radio quality information (CQI (Channel Quality Indicator)) of the downlink, acknowledgment information, a scheduling request (SR), and so on are transmitted on the PUCCH. By means of the PRACH, random access preambles for establishing connections with cells are communicated.

In the radio communication system 1, a cell-specific reference signal (CRS), a channel state information-reference signal (CSI-RS), a demodulation reference signal (DMRS), a positioning reference signal (PRS), and so on are transmitted as downlink reference signals. In the radio communication system 1, a measurement reference signal (SRS (Sounding Reference Signal)), a demodulation reference signal (DMRS), and so on are transmitted as uplink reference signals. Note that DMRS may be referred to as a “user terminal specific reference signal (UE-specific Reference Signal).” Transmitted reference signals are by no means limited to these.

### (Radio Base Station)

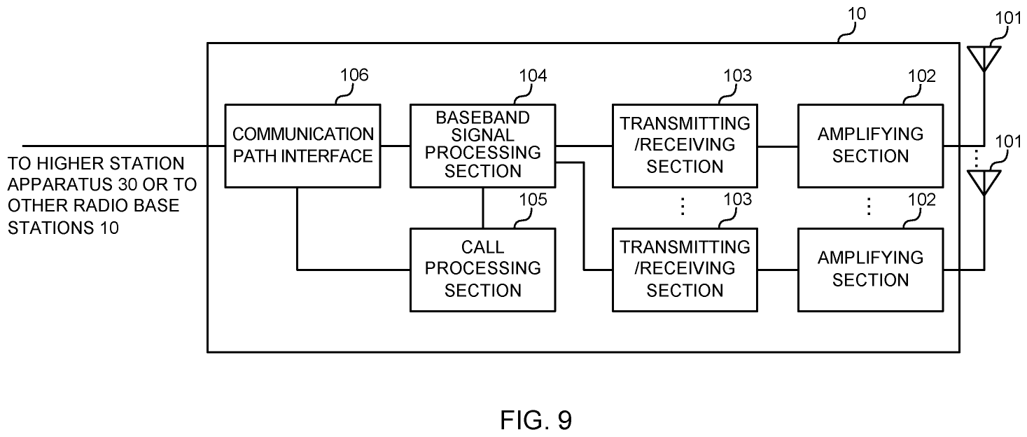

FIG. 9 is a diagram to show an example of an overall structure of a radio base station according to one embodiment of the present invention. A radio base station 10 includes a plurality of transmitting/receiving antennas 101, amplifying sections 102, transmitting/receiving sections 103, a baseband signal processing section 104, a call processing section 105, and a communication path interface 106. Note that the radio base station 10 may be configured to include one or more transmitting/receiving antennas 101, one or more amplifying sections 102 and one or more transmitting/receiving sections 103.

User data to be transmitted from the radio base station 10 to the user terminal 20 by the downlink is input from the higher station apparatus 30 to the baseband signal processing section 104, via the communication path interface 106.

In the baseband signal processing section 104, the user data is subjected to transmission processes, such as a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process, and a precoding process, and the result is forwarded to each transmitting/receiving section 103. Furthermore, downlink control signals are also subjected to transmission processes such as channel coding and inverse fast Fourier transform, and the result is forwarded to each transmitting/receiving section 103.

The transmitting/receiving sections 103 convert baseband signals that are pre-coded and output from the baseband signal processing section 104 on a per antenna basis, to have radio frequency bands and transmit the result. The radio frequency signals having been subjected to frequency conversion in the transmitting/receiving sections 103 are amplified in the amplifying sections 102, and transmitted from the transmitting/receiving antennas 101. The transmitting/receiving sections 103 can include transmitters/receivers, transmitting/receiving circuits or transmitting/receiving apparatus that can be described based on general understanding of the technical field to which the present invention pertains. Note that each transmitting/receiving section 103 may be structured as a transmitting/receiving section in one entity, or may include a transmitting section and a receiving section.

Meanwhile, as for uplink signals, radio frequency signals that are received in the transmitting/receiving antennas 101 are amplified in the amplifying sections 102. The transmitting/receiving sections 103 receive the uplink signals amplified in the amplifying sections 102. The transmitting/receiving sections 103 convert the received signals into the baseband signal through frequency conversion and outputs to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (setting up, releasing and so on) for communication channels, manages the state of the radio base station 10, manages the radio resources and so on.

The communication path interface 106 transmits and/or receives signals to and/or from the higher station apparatus 30 via a certain interface. The communication path interface 106 may transmit and/or receive signals (backhaul signaling) with other radio base stations 10 via an inter-base station interface (for example, an optical fiber in compliance with the CPRI (Common Public Radio Interface) and an X2 interface).

The transmitting/receiving sections 103 allocate at least one of a first downlink control information format and a second downlink control information format in a plurality of search space sets configured for one or more cells to transmit the downlink control information. The transmitting/receiving sections 103 receive retransmission control information (HARQ-ACK) corresponding to the downlink control information. The HARQ-ACK corresponding to the downlink control information may be interpreted as the HARQ-ACK corresponding to the DL transmission (for example, PDSCH) scheduled by way of the downlink control information.

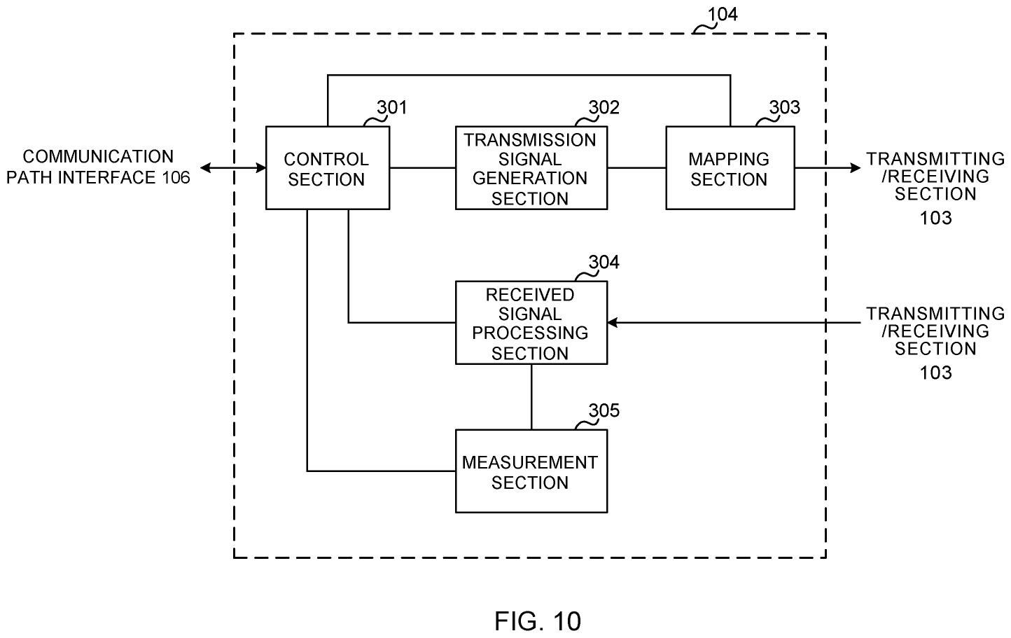

FIG. 10 is a diagram to show an example of a functional structure of the radio base station according to one embodiment of the present invention. Note that, the present example primarily shows functional blocks that pertain to characteristic parts of the present embodiment, and it is assumed that the radio base station 10 may include other functional blocks that are necessary for radio communication as well.

The baseband signal processing section 104 at least includes a control section (scheduler) 301, a transmission signal generation section 302, a mapping section 303, a received signal processing section 304, and a measurement section 305. Note that these structures may be included in the radio base station 10, and some or all of the structures do not need to be included in the baseband signal processing section 104.

The control section (scheduler) 301 controls the whole of the radio base station 10. The control section 301 can include a controller, a control circuit or control apparatus that can be described based on general understanding of the technical field to which the present invention pertains.

The control section 301, for example, controls the generation of signals in the transmission signal generation section 302, the mapping of signals by the mapping section 303, and so on. The control section 301 controls the signal receiving processes in the received signal processing section 304, the measurements of signals in the measurement section 305, and so on.

The control section 301 controls scheduling (for example, resource allocation) of system information, a downlink data signal (for example, a signal transmitted on a PDSCH), and a downlink control signal (for example, a signal transmitted on a PDCCH and/or an EPDCCH, acknowledgment information, and so on). Based on the results of determining necessity or not of retransmission control to the uplink data signal, or the like, the control section 301 controls generation of a downlink control signal, a downlink data signal, and so on. The control section 301 controls the scheduling of a synchronization signal (for example, a PSS (Primary Synchronization Signal)/an SSS (Secondary Synchronization Signal)), a downlink reference signal (for example, a CRS, a CSI-RS, a DMRS), and so on.

The control section 301 controls scheduling of an uplink data signal (for example, a signal transmitted on the PUSCH), an uplink control signal (for example, a signal transmitted on the PUCCH and/or the PUSCH, acknowledgment information, and so on), a random access preamble (for example, a signal transmitted on the PRACH), an uplink reference signal, and so on.

The control section 301 may control the counter DAI value based on at least one of the cell index, the search space index, and the downlink control information format type. For example, the control section 301 may determine the counter DAI value corresponding to a certain cell based on the search space index configured for the certain cell, and determine the counter DAI values of different cells based on the cell indexes.

Alternatively, the control section 301 may control an accumulation order of the counter DAI values in a certain cell such that the second DCI format is prioritized more than the first DCI format. Alternatively, the control section 301 may determine the counter DAI values corresponding to the respective cells based on the downlink control information format type. Alternatively, the control section 301 may control the accumulation order of the counter DAI values in a plurality of cells such that the second DCI format is prioritized more than the first DCI format.

The transmission signal generation section 302 generates downlink signals (downlink control signals, downlink data signals, downlink reference signals and so on) based on commands from the control section 301 and outputs the downlink signals to the mapping section 303. The transmission signal generation section 302 can include a signal generator, a signal generation circuit or signal generation apparatus that can be described based on general understanding of the technical field to which the present invention pertains.

For example, the transmission signal generation section 302 generates DL assignment to report assignment information of downlink data and/or UL grant to report assignment information of uplink data, based on commands from the control section 301. The DL assignment and the UL grant are both DCI, and follow the DCI format. For a downlink data signal, encoding processing and modulation processing are performed in accordance with a coding rate, modulation scheme, or the like determined based on channel state information (CSI) from each user terminal 20, and so on.

The mapping section 303 maps the downlink signals generated in the transmission signal generation section 302 to certain radio resources, based on commands from the control section 301, and outputs these to the transmitting/receiving sections 103. The mapping section 303 can include a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals are, for example, uplink signals that are transmitted from the user terminals 20 (uplink control signals, uplink data signals, uplink reference signals and so on). The received signal processing section 304 can include a signal processor, a signal processing circuit or signal processing apparatus that can be described based on general understanding of the technical field to which the present invention pertains.

The received signal processing section 304 outputs the decoded information acquired through the receiving processes to the control section 301. For example, if the received signal processing section 304 receives the PUCCH including HARQ-ACK, the received signal processing section 304 outputs the HARQ-ACK to the control section 301. The received signal processing section 304 outputs the received signals and/or the signals after the receiving processes to the measurement section 305.

The measurement section 305 conducts measurements with respect to the received signals. The measurement section 305 can include a measurer, a measurement circuit or measurement apparatus that can be described based on general understanding of the technical field to which the present invention pertains.

For example, the measurement section 305 may perform RRM (Radio Resource Management) measurement, CSI (Channel State Information) measurement, and so on, based on the received signal. The measurement section 305 may measure a received power (for example, RSRP (Reference Signal Received Power)), a received quality (for example, RSRQ (Reference Signal Received Quality), an SINR (Signal to Interference plus Noise Ratio), an SNR (Signal to Noise Ratio)), a signal strength (for example, RSSI (Received Signal Strength Indicator)), channel information (for example, CSI), and so on. The measurement results may be output to the control section 301.

### (User Terminal)

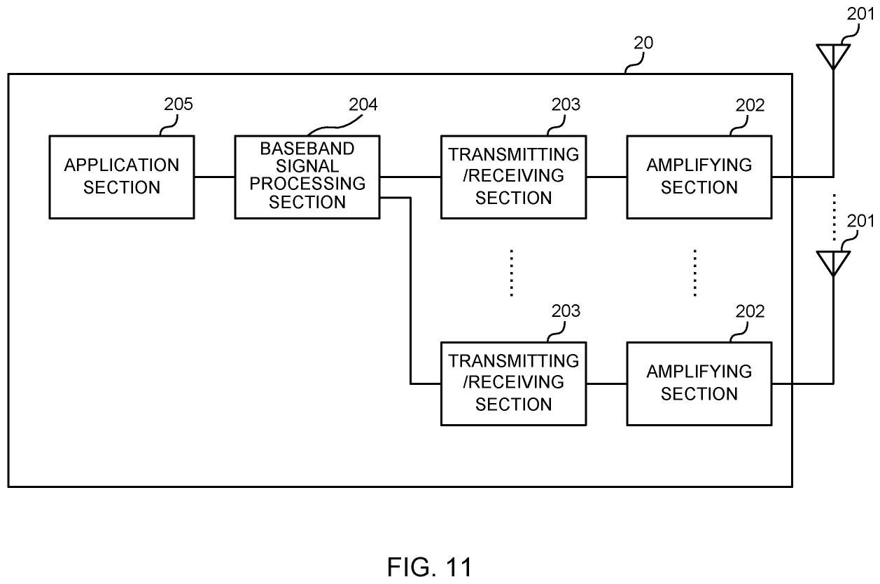

FIG. 11 is a diagram to show an example of an overall structure of a user terminal according to one embodiment of the present invention. A user terminal 20 includes a plurality of transmitting/receiving antennas 201, amplifying sections 202, transmitting/receiving sections 203, a baseband signal processing section 204, and an application section 205. Note that the user terminal 20 may be configured to include one or more transmitting/receiving antennas 201, one or more amplifying sections 202, and one or more transmitting/receiving sections 203.

Radio frequency signals that are received in the transmitting/receiving antennas 201 are amplified in the amplifying sections 202. The transmitting/receiving sections 203 receive the downlink signals amplified in the amplifying sections 202. The transmitting/receiving sections 203 convert the received signals into baseband signals through frequency conversion, and output the baseband signals to the baseband signal processing section 204. The transmitting/receiving sections 203 can include transmitters/receivers, transmitting/receiving circuits or transmitting/receiving apparatus that can be described based on general understanding of the technical field to which the present invention pertains. Note that each transmitting/receiving section 203 may be structured as a transmitting/receiving section in one entity, or may include a transmitting section and a receiving section.

The baseband signal processing section 204 performs, on each input baseband signal, an FFT process, error correction decoding, a retransmission control receiving process, and so on. The downlink user data is forwarded to the application section 205. The application section 205 performs processes related to higher layers above the physical layer and the MAC layer, and so on. In the downlink data, broadcast information may be also forwarded to the application section 205.

Meanwhile, the uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203. The transmitting/receiving sections 203 convert the baseband signals output from the baseband signal processing section 204 to have radio frequency band and transmit the result. The radio frequency signals having been subjected to frequency conversion in the transmitting/receiving sections 203 are amplified in the amplifying sections 202, and transmitted from the transmitting/receiving antennas 201.

The transmitting/receiving sections 203 monitor at least one of a first downlink control information format and a second downlink control information format in a plurality of search space sets configured for one or more cells to receive one or more pieces of downlink control information. The transmitting/receiving sections 203 transmit retransmission control information (HARQ-ACK) corresponding to the downlink control information.

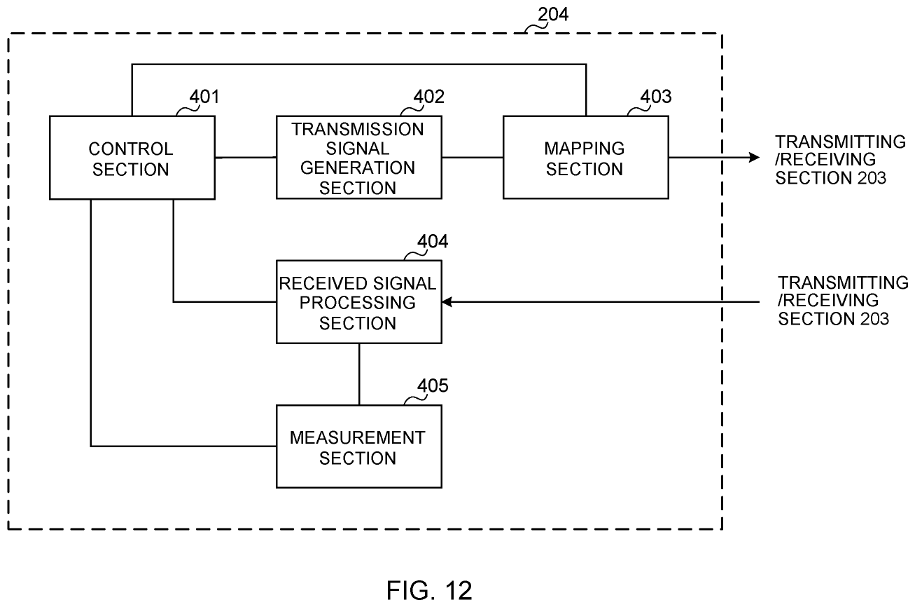

FIG. 12 is a diagram to show an example of a functional structure of the user terminal according to one embodiment of the present invention. Note that, the present example primarily shows functional blocks that pertain to characteristic parts of the present embodiment, and it is assumed that the user terminal 20 may include other functional blocks that are necessary for radio communication as well.

The baseband signal processing section 204 provided in the user terminal 20 at least includes a control section 401, a transmission signal generation section 402, a mapping section 403, a received signal processing section 404 and a measurement section 405. Note that these structures may be included in the user terminal 20, and some or all of the structures do not need to be included in the baseband signal processing section 204.

The control section 401 controls the whole of the user terminal 20. The control section 401 can include a controller, a control circuit or control apparatus that can be described based on general understanding of the technical field to which the present invention pertains.

The control section 401, for example, controls the generation of signals in the transmission signal generation section 402, the mapping of signals by the mapping section 403, and so on. The control section 401 controls the signal receiving processes in the received signal processing section 404, the measurements of signals in the measurement section 405, and so on.

The control section 401 acquires a downlink control signal and a downlink data signal transmitted from the radio base station 10, from the received signal processing section 404. The control section 401 controls generation of an uplink control signal and/or an uplink data signal, based on the results of determining necessity or not of retransmission control to a downlink control signal and/or a downlink data signal.

The control section 401 may control the HARQ-ACK transmission assuming that at least one of the HARQ-ACK bit position and the downlink assignment index counter value (counter DAI value) is determined based on at least one of the cell index, the search space index, and the downlink control information format type.

Alternatively, the control section 401 may control the HARQ-ACK transmission assuming that at least one of the HARQ-ACK bit position and the counter DAI value corresponding to a certain cell is determined based on the search space index configured for the certain cell, and at least one of the HARQ-ACK bit position and the counter DAI value of different cells is determined based on the cell index.

Alternatively, the control section 401 may control the HARQ-ACK transmission assuming that at least one of the HARQ-ACK bit position order and the accumulation order of the counter DAI values in a certain cell is configured with the second DCI format being prioritized more than the first DCI format.

Alternatively, the control section 401 may control the HARQ-ACK transmission assuming that at least one of the HARQ-ACK bit position and the counter DAI value corresponding to each cell is determined based on the downlink control information format type.

Alternatively, the control section 401 may control the HARQ-ACK transmission assuming that at least one of the HARQ-ACK bit position order and the accumulation order of the counter DAI values in a plurality of cells is configured with the second DCI format being prioritized more than the first DCI format.

The transmission signal generation section 402 generates uplink signals (uplink control signals, uplink data signals, uplink reference signals and so on) based on commands from the control section 401, and outputs the uplink signals to the mapping section 403. The transmission signal generation section 402 can be constituted with a signal generator, a signal generation circuit or signal generation apparatus that can be described based on general understanding of the technical field to which the present invention pertains.

For example, the transmission signal generation section 402 generates an uplink control signal about the acknowledge information, the channel state information (CSI), and so on, based on commands from the control section 401. The transmission signal generation section 402 generates uplink data signals, based on commands from the control section 401. For example, when a UL grant is included in a downlink control signal that is reported from the radio base station 10, the control section 401 commands the transmission signal generation section 402 to generate the uplink data signal.

The mapping section 403 maps the uplink signals generated in the transmission signal generation section 402 to radio resources, based on commands from the control section 401, and outputs the result to the transmitting/receiving sections 203. The mapping section 403 can include a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals are, for example, downlink signals transmitted from the radio base station 10 (downlink control signals, downlink data signals, downlink reference signals and so on). The received signal processing section 404 can include a signal processor, a signal processing circuit or signal processing apparatus that can be described based on general understanding of the technical field to which the present invention pertains. The received signal processing section 404 can constitute the receiving section according to the present invention.

The received signal processing section 404 outputs the decoded information acquired through the receiving processes to the control section 401. The received signal processing section 404 outputs, for example, broadcast information, system information, RRC signaling, DCI and so on, to the control section 401. The received signal processing section 404 outputs the received signals and/or the signals after the receiving processes to the measurement section 405.

The measurement section 405 conducts measurements with respect to the received signals. The measurement section 405 can include a measurer, a measurement circuit or measurement apparatus that can be described based on general understanding of the technical field to which the present invention pertains.

For example, the measurement section 405 may perform RRM measurement, CSI measurement, and so on, based on the received signal. The measurement section 405 may measure a received power (for example, RSRP), a received quality (for example, RSRQ, SINR, SNR), a signal strength (for example, RSSI), channel information (for example, CSI), and so on. The measurement results may be output to the control section 401.

### (Hardware Structure)

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these plurality of pieces of apparatus.

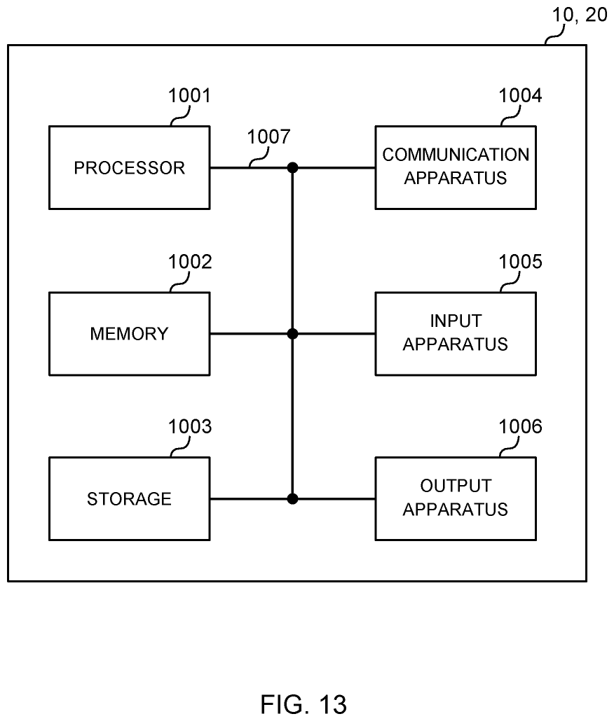

For example, a radio base station, a user terminal, and so on according to one embodiment of the present invention may function as a computer that executes the processes of the radio communication method of the present invention. FIG. 13 is a diagram to show an example of a hardware structure of the radio base station and the user terminal according to one embodiment of the present invention. Physically, the above-described radio base station 10 and user terminals 20 may each be formed as computer apparatus that includes a processor 1001, a memory 1002, a storage 1003, a communication apparatus 1004, an input apparatus 1005, an output apparatus 1006, a bus 1007, and so on.

Note that, in the following description, the word “apparatus” may be interpreted as “circuit,” “device,” “unit,” and so on. The hardware structure of the radio base station 10 and the user terminals 20 may be designed to include one or a plurality of apparatuses shown in the drawings, or may be designed not to include part of pieces of apparatus.

For example, although only one processor 1001 is shown, a plurality of processors may be provided. Furthermore, processes may be implemented with one processor or may be implemented at the same time, in sequence, or in different manners with one or more processors. Note that the processor 1001 may be implemented with one or more chips.

Each function of the radio base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control reading and/or writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so on from the storage 1003 and/or the communication apparatus 1004, into the memory 1002, and executes various processes according to these. As for the programs, programs to allow computers to execute at least part of the operations of the above-described embodiments are used. For example, the control section 401 of each user terminal 20 may be implemented by control programs that are stored in the memory 1002 and that operate on the processor 1001, and other functional blocks may be implemented likewise.

The memory 1002 is a computer-readable recording medium, and may include, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present invention.

The storage 1003 is a computer-readable recording medium, and may include, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via a wired and/or wireless network, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106, and so on may be implemented by the communication apparatus 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, an LED (Light Emitting Diode) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the radio base station 10 and the user terminals 20 may be structured to include hardware such as a microprocessor, a digital signal processor (DSP), an ASIC (Application Specific Integrated Circuit), a PLD (Programmable Logic Device), an FPGA (Field Programmable Gate Array), and so on, and part or all of the functional blocks may be implemented by the hardware. For example, the processor 1001 may be implemented with at least one of these pieces of hardware.

### (Variations)

Note that the terminology described in this specification and/or the terminology that is needed to understand this specification may be replaced by other terms that convey the same or similar meanings. For example, “channels” and/or “symbols” may be “signals” (“signaling”). Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Furthermore, a slot may be constituted of one or a plurality of symbols in the time domain (OFDM (Orthogonal Frequency Division Multiplexing) symbols, SC-FDMA (Single Carrier Frequency Division Multiple Access) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.”

A radio frame, a subframe, a slot, a mini-slot, and a symbol all express time units in signal communication. A radio frame, a subframe, a slot, a mini-slot, and a symbol may each be called by other applicable terms. For example, one subframe may be referred to as a “transmission time interval (TTI),” a plurality of consecutive subframes may be referred to as a “TTI” or one slot or one mini-slot may be referred to as a “TTI.” That is, a subframe and/or a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a radio base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, and/or codewords, or may be the unit of processing in scheduling, link adaptation, and so on. Note that, when TTIs are given, the time interval (for example, the number of symbols) to which transport blocks, code blocks, and/or codewords are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. Also, an RB may include one or a plurality of symbols in the time domain, and may be one slot, one mini-slot, one subframe, or one TTI in length. One TTI and one subframe each may be constituted of one or a plurality of resource blocks. Note that one or a plurality of RBs may be referred to as a “physical resource block (PRB (Physical RB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in this specification may be represented in absolute values or in relative values with respect to certain values, or may be represented in another corresponding information. For example, radio resources may be specified by certain indices.

The names used for parameters and so on in this specification are in no respect limiting. For example, since various channels (PUCCH (Physical Uplink Control Channel), PDCCH (Physical Downlink Control Channel), and so on) and information elements can be identified by any suitable names, the various names allocated to these various channels and information elements are in no respect limiting.

The information, signals, and so on described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as an “RRC message,” and can be, for example, an RRC connection setup (RRCConnectionSetup) message, an RRC connection reconfiguration (RRCConnectionReconfiguration) message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” used in this specification can be used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts, and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up, (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions and/or (both visible and invisible) optical regions, or the like.

In this specification, the phrase “A and B are different” may mean that “A and B are different from each other.” The terms “separate,” “be coupled” and so on may be interpreted similarly.

When terms such as “including,” “comprising,” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described in this specification. The present invention can be implemented with various corrections and in various modifications, without departing from the spirit and scope of the present invention defined by the recitations of claims. Consequently, the description in this specification is provided only for the purpose of explaining examples, and should by no means be construed to limit the present invention in any way.

1. A user terminal comprising:
a receiving section that monitors at least one of a first downlink control information format and a second downlink control information format in a plurality of search space sets configured for one or more cells to receive one or more pieces of downlink control information; and
a control section that controls transmission of retransmission control information (HARQ-ACK) corresponding to the downlink control information,
wherein at least one of a bit position of the HARQ-ACK and a downlink assignment index counter value (counter DAI value) is determined based on at least one of a cell index, a search space index, and a downlink control information format type.

2. The user terminal according to claim 1, wherein
at least one of the HARQ-ACK bit position and the counter DAI value corresponding to a certain cell is determined based on the search space index configured for the certain cell, and at least one of the HARQ-ACK bit position and the counter DAI value of different cells is determined based on the cell index.

3. The user terminal according to claim 1, wherein
the second downlink control information format is a format that includes a downlink assignment index total value (total DAI), and the first downlink control information format is a format that does not include the total DAI, and
at least one of a HARQ-ACK bit position order and an accumulation order of counter DAI values in a certain cell is configured with the second DCI format being prioritized more than the first DCI format.

4. The user terminal according to claim 1, wherein
at least one of the HARQ-ACK bit position and the counter DAI value corresponding to each cell is determined based on the downlink control information format type.

5. The user terminal according to claim 1, wherein
the second downlink control information format is a format that includes a downlink assignment index total value (total DAI), and the first downlink control information format is a format that does not include the total DAI, and
at least one of a HARQ-ACK bit position order and an accumulation order of the counter DAI values in a plurality of cells is configured with the second DCI format being prioritized more than the first DCI format.

6. A radio communication method comprising:
monitoring at least one of a first downlink control information format and a second downlink control information format in a plurality of search space sets configured for one or more cells to receive one or more pieces of downlink control information; and
controlling transmission of retransmission control information (HARQ-ACK) corresponding to the downlink control information,
wherein at least one of a bit position of the HARQ-ACK and a downlink assignment index counter value (counter DAI value) is determined based on at least one of a cell index, a search space index, and a downlink control information format type.

7. The user terminal according to claim 2, wherein
the second downlink control information format is a format that includes a downlink assignment index total value (total DAI), and the first downlink control information format is a format that does not include the total DAI, and
at least one of a HARQ-ACK bit position order and an accumulation order of counter DAI values in a certain cell is configured with the second DCI format being prioritized more than the first DCI format.

8. The user terminal according to claim 4, wherein
the second downlink control information format is a format that includes a downlink assignment index total value (total DAI), and the first downlink control information format is a format that does not include the total DAI, and
at least one of a HARQ-ACK bit position order and an accumulation order of the counter DAI values in a plurality of cells is configured with the second DCI format being prioritized more than the first DCI format.
